(19) United States
(12) Patent Application Publication
(10) Pub. No.: US 2002/0054672 A1
(43) Pub. Date: May 9, 2002

(54) Method of paying for transactions performed for example on internet

(76) Inventor: Guillaume De Laubadere, Lyon (FR)

Correspondence Address: HESLIN ROTHENBERG FARLEY & MESITI PC, 5 COLUMBIA CIRCLE, ALBANY, NY, 12203, US

(21) Appl. No.: 09/776,111

(22) Filed: Feb. 2, 2001

(30) Foreign Application Priority Data
Nov. 6, 2000 (FR) 00 14163

(51) Int. Cl. H04M 15/00

(52) U.S. Cl. 379/114.01; 379/112.01

(57) ABSTRACT

A method of paying for transactions between a user (1) and a trader site (3), comprising a step during which the trader site (1) displays, on a terminal available to the user, information relating to the transaction and to the mode of payment, wherein it comprises the following subsequent steps, during which, starting from the moment at which the user (1) has opted for a mode of payment by billing for the use of a premium rate telephone line:

a) the user (1) is rerouted to a validation Internet site (4), with the dispatching to the said site of the information relating to the transaction;

b) the validation Internet site (4) dispatches to the user (1), via Internet:

the telephone number of a premium rate line, the communication cost of which corresponds substantially to the price of the transaction;

a control code; while requesting the user (1) to key in the telephone number displayed, followed by the control code, and finally to confirm the operation via Internet;

c) on receipt of the call from the user, a telephone handler (5) associated with the premium rate line informs the confirmation Internet site (4) of the control code keyed in, and of the date of the call;

d) the validation Internet site (4) verifies the receipt of the control code transmitted by the handler (5) and of the validation command dispatched by the user (1);

e) the validation Internet site (4) triggers an authorization process allowing the completion of the transaction between the trader site (3) and the user (1).

### FIELD OF THE INVENTION

The invention concerns the field of telematics, and more precisely electronic commerce. It is more particularly aimed at a method of paying for transactions performed via Internet. These transactions may relate to material goods, but also to services, such as the displaying of pay-per-use information, or the downloading of computer files. This method is aimed, on the one hand, at providing the trader site with a guarantee of being actually paid by the user and, on the other hand, at ensuring the anonymity of the user during his purchase, and security through the absence of sensitive information such as bank account or credit card numbers.

### PRIOR ART

Since the appearance of telematics-based commerce, numerous solutions have already been proposed for ensuring the proper conduct of transactions, for the buyer and the seller.

A first solution is known which is much like traditional commerce. Thus, after having recorded the order placed by Internet, the seller or the trader site sends a bill to the user or to the customer. The settling of this bill is a necessary condition for delivery and hence for completion of the transaction. It is appreciated that this procedure, whilst it guarantees trader site payment, nevertheless has the major drawback of being particularly slow, and hence in contradiction with the necessary immediacy of certain transactions such as in particular file downloads.

Another solution is known which makes it possible to ensure payment for transactions, by means of a credit card. Thus, to validate his transaction, the purchaser must enter his credit card number into a reserved space of the trader site, which is in general secure. The system put in place by the trader site verifies the validity of the number as a function of a secret algorithm and thus authorizes or disallows the transaction.

This system has a number of advantages, and in particular the fact that it is very widespread. Furthermore, it is suitable for all types of amounts and of currencies. Finally, it generally operates together with a system of assurance between the company issuing the credit cards and the trader site, so that the latter is very often assured of being able to recover the amount of the transaction, even if failures have occurred during this transaction.

However, this system has significant drawbacks. Specifically, the credit card number typed in by the purchaser travels over Internet, and hence third parties may possibly have access to it. Furthermore, the operation of entering the credit card information is generally fairly lengthy, more than three minutes on average. Additionally, the validity control algorithms for credit cards not being completely secret, the possibility exists of making payments by means of contrived credit card numbers, which allow validation of the transaction, but which will never give rise to trader site payment. Furthermore, the transactions performed by this means are debited from the account associated with the credit card, so that the manager of this account can be kept abreast of the purchaser's various transactions. Stated otherwise, the transactions are not anonymous, and this may constitute a curb on certain transactions.

To summarize, the system for on-line entry of credit card numbers is relatively unsafe, non-confidential and tedious as far as entry is concerned.

It has already been proposed that the system for payment by credit cards be upgraded by associating a card reader with the computer which allows on-Internet navigation. This reader allows the entry of the confidential code (“PIN” code or “Personal Identification Number”) and hence interrogation of the electronic chip of the card. It is the reader which delivers the cue according to which the confidential code is correct, thus authorizing the transaction. The addition of this reader has the advantage of decreasing the transaction time and of psychological reassurance. However, the drawbacks already mentioned in respect of the on-line entry of the credit card number remains, since the card number travels over Internet, and since the system is “piratable”, it being possible to reproduce the cue delivered by the chip card reader and according to which the card has been validated by the keying in of the secret code.

Furthermore, this system requires a special reader which only a very small number of microcomputers are equipped with and hence, for this reason, its generalization is very limited.

Additionally, another possibility of making payments for transactions on Internet is known which operates with a subscription mechanism. More precisely, according to this system, the user pays the manager of the subscription an agreed fixed sum, then consumes the asset in tranches. For the user, this system has the advantage that the transaction itself is relatively fast, since it is generally necessary to key in a single unique code.

At the trader site end, the advantage lies in the security of payment which is near-certain, since the purchaser must pay before consuming. Stated otherwise, the trader manages assets. Furthermore, the customers benefiting from this kind of subscription have a tendency to overconsume without giving any attention thereto, this being favorable to the trader site.

However, this system has significant drawbacks. Specifically, the codes allotted to the subscribers travel over Internet, so that they are “piratable”, and so that the security of this subscription formula is not actually different from that of payment by credit card. Additionally, the setting in place of the subscription formula is relatively unwieldy and lengthy. Furthermore, the purchaser bears the financial risk of the disappearance of the subscription manager. Finally and above all, the transaction is not absolutely anonymous, thereby possibly raising the confidentiality problems already mentioned.

A variant of this system has been described in the document WO 99/22507. More precisely, this document describes the possibility of crediting a subscription account while the user remains connected to Internet. Thus, when the user wishes to put funds into his account, he establishes a telephone link with a specific operator, not via a conventional telephone line, but via the Internet network. After having keyed in an identification code, he can then put the desired sum into his account. He is then billed for this amount by the telephone operator.

This mechanism suffers from the same drawbacks as those mentioned in respect of payments by credit card, since the identification number travels over Internet.

Additionally, another procedure is known for making payments for a transaction performed via Internet, which operates by virtue of the management of the Internet access provider's account. More precisely, numerous users linked to Internet are so via a pay-per-use access provider who bills the user on a monthly basis. In certain cases, the trader sites can arrange a contract with the Internet access providers which provides for the payment for the service which they are selling to be added to the bill issued by the access provider to the user.

This system has the advantage of ensuring better security than the systems already described, in the sense that the Internet access provider has a means of checking the origin of the user's logons. Stated otherwise, the Internet access provider has the possibility of verifying, with the IP addresses, that the potential purchaser is indeed one of its customers. However, this system has various drawbacks and in particular the fact that the trader site has to have ties with a maximum number of Internet access providers. Stated otherwise, under this logic, the transactions cannot be paid for when the customer uses the services of an Internet access provider who does not himself have a tie with the trader site.

Furthermore, in order to settle up, the trader sites have to issue bills to all the Internet access providers and wait for the latter to have collected the sums before settling up.

Finally and above all, this system is totally incompatible with Internet access providers who offer free access, and who have no contractual ties with their customer.

Additionally, certain trader sites, and essentially the publishers of works with an erotic content, offer a specific procedure for paying for the services which they offer. More precisely, in this illustrative case, the user must download software onto his computer. This software changes the usual Internet access configuration, in favor of a link to a server via a premium rate line whose cost depends on the duration of connection.

This system has the advantage of ensuring the anonymity of consumption, since the billing is indistinguishable from the other services billed by means of premium rate lines. Furthermore, the pirating of such a system is extremely difficult since it depends on the configuration of the premium rate lines.

Furthermore, a telephone operator who is responsible for collecting the sums corresponding to the levels of consumption generally guarantees the payments to the trader site.

However, this system has multiple drawbacks. From a technical point of view, the specific software very often disrupts primary access to the Internet network, and it is not always easy to reconfigure it correctly for usage outside of this specific service.

Furthermore, the operation of downloading and installing the software is rarely simple. Additionally, this means of payment is impossible to implement on computers which access the Internet via a common access of the router type or networked access, rather than via a conventional telephone line. Finally, each trader site has to provide the user with its own software, containing the parameters of its premium rate line, and access is therefore limited to a specific service by each piece of software.

Additionally, the document WO 97/01920 describes another mechanism for paying for transactions performed by Internet. More precisely, in this mechanism, when the user has selected a pay-per-use service on a trader site, the trader site sends its customer a particular telephone number of the same telephone operator as that used for the Internet links. When the user calls this particular number, he is sent, by voice message, a code number which the user has to type into his terminal.

The user is then billed by the telephone operator who reimburses the trader site with a portion of the sums received. This system has multiple drawbacks, and in particular that of requiring a contractual tie between the trader site and each of the telephone operators to which his customers might subscribe. Furthermore, it is necessary for the various telephone lines allowing access to the Internet and billing to be lines belonging to the same telephone operator, this being restrictive and in particular precluding the use of a portable telephone for this mode of payment.

This system is therefore unwieldy to implement for the trader site, which must furthermore multiply its contacts with operators if it wishes to perform transactions abroad.

Another means of payment for transactions performed by Internet is described in the document U.S. 5,745,556.

This document describes the possibility of a trader site equipping itself with a telephone handler operating with premium rate lines. More precisely, the proposed solution requires for each trader site the use of a telephone handler possessing a significant number of lines, corresponding to the various amounts of the facilities of the trader site. It is appreciated that this solution, although it assures the trader site of security of payment, nevertheless has the major drawback of being particularly unwieldy to implement since it corresponds to a significant investment for each trader site.

Furthermore, a technical problem arises and prevents the generalizing of this system, since the number of premium rate line telephone numbers is necessarily limited, and since not all the existing trader sites can be allotted therewith in sufficient number to cover the entire price range of each of them.

The various aforesaid drawbacks are solved by the present invention, the objective of which is to provide a payment system which is at once safe for the user and the trader site, which preserves the anonymity of the transactions and which can easily be implemented without requiring significant investment from the trader site, whilst permitting international transactions.

### DESCRIPTION OF THE INVENTION

The invention therefore relates to a method of paying for transactions between a user and a trader site. This method comprises a known step during which the trader site displays, on a terminal available to the user, information relating to the transaction and to the mode of payment.

The method in accordance with the invention is one wherein it comprises the following subsequent steps, during which, starting from the moment at which the user has opted for a mode of payment by billing for the use of a premium rate telephone line:

a) the user is rerouted to a validation Internet site, with the dispatching to the said site of information relating to the transaction;

b) the validation Internet site dispatches to the user, via Internet:

the telephone number of a premium rate line, the communication cost of which corresponds substantially to the price of the transaction;

a control code; while requesting the user to key in the telephone number displayed, followed by the control code, and finally to confirm the operation via Internet;

c) on receipt of the call from the user, a telephone handler associated with the premium rate line informs the validation Internet site of the identification code keyed in, and of the date of the call;

d) the validation Internet site verifies the receipt of the control code transmitted by the handler and of the confirmation command dispatched by the user;

e) the validation Internet site triggers an authorization process allowing the completion of the transaction between the trader site and the user.

Stated otherwise, the payment mechanism in accordance with the invention involves a third party, the validation Internet site, which is independent of the customer and of the trader site. More precisely, the validation Internet site receives, from the trader site, information in a predetermined format, which allows it to formulate a premium rate line telephone number as a function of the price of the facility to be paid for and possibly of other parameters specific to the transaction. This number is then transmitted to the customer via an Internet session. When the customer calls this telephone number of the premium rate line, he is billed by the telephone operator who himself reimburses the validation Internet site with a portion of this billing. It is the validation Internet site which then reimburses the trader site with a portion of the sums received from the telephone operator.

On account of the contractual relationships existing between, on the one hand, the validation Internet site and the trader site and, on the other hand, the telephone operator and the validation Internet site, the security of the payment is ensured.

The payment system is particularly reliable, since as soon as the user has keyed in the control code provided with the number of the premium rate line, the corresponding amount is charged to his telephone bill, and the telephone operator undertakes to reimburse the validation Internet site with a portion of this sum. The validation Internet site itself undertaking to reimburse most of the sums collected on behalf of the trader, the latter is assured of effective payment.

The process furthermore has the advantage of being particularly simple since it is merely necessary for the trader site to authorize the mode of payment via the validation Internet site so as to be assured of collecting the sums corresponding to the services and/or goods sold.

Furthermore, the system preserves the anonymity of the user, since the latter does not need to indicate his particulars in order for the payment to take place. The billing of the services or goods purchased is done on his telephone bill, unconnected with the name of the trader site. Specifically, the telephone bill generally groups together all consumption on the premium rate lines. In the case where this bill itemizes this consumption on the basis of the premium rate line numbers, it is impossible with this telephone bill to make the relationship between the number keyed in and the trader site.

Stated otherwise, the action which generates the payment, that is to say the keying-in of the number of the premium rate line and of the control code, is asynchronous with the method of transaction proper, and without interference or prompting in the conduct of the latter.

Obviously, the invention finds a direct application to transactions performed on Internet subsequent to navigation carried out around the web pages of the trader site. Nevertheless, it can be carried over to transactions performed more generally via a vehicle other than Internet in the strict sense. Thus, the transaction can result from looking up offers of goods and/or services provided on a medium making it possible, Internet-fashion, to present information in interactive form.

It may, for example, be a transaction relating to the viewing of a film or of a transmission broadcast on a pay-per-view television network.

Additionally, the dispatching of information, and in particular the telephone number and control code, from the trader site to the user may be done within the context of an Internet session, on any terminal connected to Internet.

Nevertheless, more generally, this dispatching can also take place on a terminal which is not directly connected to Internet, but which is connected to the validation Internet site by a composite link, including a pathway for information via Internet. Specifically, in certain illustrative cases, and for example in the case of the use of a portable telephone operating according to WAP technology, the terminal available to the user, that is to say the portable telephone, is not directly linked to Internet, but to a telephone network which is itself linked to Internet, and hence to the validation Internet site.

Additionally, the method in accordance with the invention has the advantage that it can be adapted to transactions between a user and a trader site situated in different countries. Specifically, according to another characteristic of the invention, during the rerouting, the validation Internet site receives a cue relating to the country in which the user is located. In this way, it displays to the user the number of the premium rate line which is that of a telephone network of the relevant country.

Stated otherwise, when the user chooses the mode of payment in accordance with the invention, the validation site is informed of the country of the user. This further information can, for example, be the language of installation of the Internet navigation software used to perform the transactions.

In this way, the validation Internet site determines the premium rate line numbers in force in the country in question. The validation Internet site is therefore associated with a telephone operator in each country, each operator making a list of premium rate line numbers available to the validation Internet site. It is the telephone operator of each country who reimburses the validation Internet site with a portion of the cost of consumption of the premium rate lines.

The system is not however totally conditioned by the country-related information dispatched by the user. To this end, during the displaying of the telephone number of the premium rate line, the user can be offered the choice of modifying the country displayed. Such a modification generates the dispatching of a request destined for the validation Internet site, then the reformulating by the validation Internet site of a new premium rate line telephone number, corresponding to the modified country.

Stated otherwise, the user is given the possibility of modifying the default country detected by the validation Internet site, in the case where, for example, a portable computer, installed with an Internet navigator in a given language, is connected to Internet in a different country.

The telephone line used for the call of the premium rate line can be different from that used for the Internet link. Thus, when the user is linked to Internet via a local network, he can use an independent telephone line or else a portable telephone to key in the number of the premium rate line followed by his identification code.

It may however involve the same line in the case where Internet access is achieved via an ISDN line. It may also be possible to use one and the same line by disconnecting Internet access temporarily, while the user keys in the premium rate line. Internet access can then be re-established when requested by the user or even automatically.

Advantageously in practice, the keying-in of the identification code brings about the dispatching of DTMF signals to the telephone handler. The use of these multifrequency signals is in fact very widespread over all existing telephone networks and involves the sole recognition which has to be performed by the telephone handler associated with the premium rate lines.

In a variant embodiment, the telephone number of the premium rate line and the control code can be keyed in automatically as soon as the user has confirmed the operation in the Internet session opened by the validation Internet site. Stated otherwise, in the window displaying the number of the premium rate line and the control code, it is necessary to click on a confirmation button or to perform an equivalent action. Through this action, the validation Internet site is sent the cue according to which the user confirms that he has keyed in the number of the premium rate line, followed by the control code.

In a variant, clicking may prompt, via a modem or any other similar device, the keying-in of the number of the premium rate line, followed by that of the control code. Stated otherwise, the user need not manually key in the telephone number of the premium rate line, but this call is initiated automatically. It should be noted that although the operation is automated, the premium rate line is actually called, and always in a manner which is asynchronous with respect to the sequencing of the various steps of the transaction via Internet.

Advantageously in practice, the control code allocated to a transaction by the validation Internet site can be generated randomly. One thus avoids the problems of excessive crowding, which could give rise to excessively long response times if the control codes are generated sequentially.

Advantageously in practice, the control codes and their date of allocation by the validation Internet site are stored in a database managed by the latter site.

Advantageously in practice, during the verification step, the validation Internet site calculates the duration elapsed between the allocating of the control code and the later of the two events, viz. the receiving of the confirmation command and the keying-in of the control code. The authorization process is triggered only if this duration is less than a predetermined limit duration. Stated otherwise, the control codes are valid only for a predetermined duration, of the order of a few minutes, and are then put back into play.

The identification codes are therefore reusable if the transaction did not take place fast enough after the control code was allocated. This makes it possible to reuse the same number subsequently with a view to another transaction.

The maximum number of numbers to be allocated is thus limited, thereby limiting their number of digits or of characters of the identification code. In practice, the use of four or five characters is sufficient overall.

### BRIEF DESCRIPTION OF THE FIGURES

The manner in which the invention may be embodied as well as the advantages which stem therefrom will emerge clearly from the description of a particular embodiment of the method in accordance with the invention, in support of the appended figures, in which:

FIG. 1 is a general diagram indicating the various parties and devices involved in the method in accordance with the invention.

FIGS. 2 to 11 are diagrams arising from FIG. 1, each illustrating a particular step of the method in accordance with the invention.

### MANNER OF EMBODYING THE INVENTION

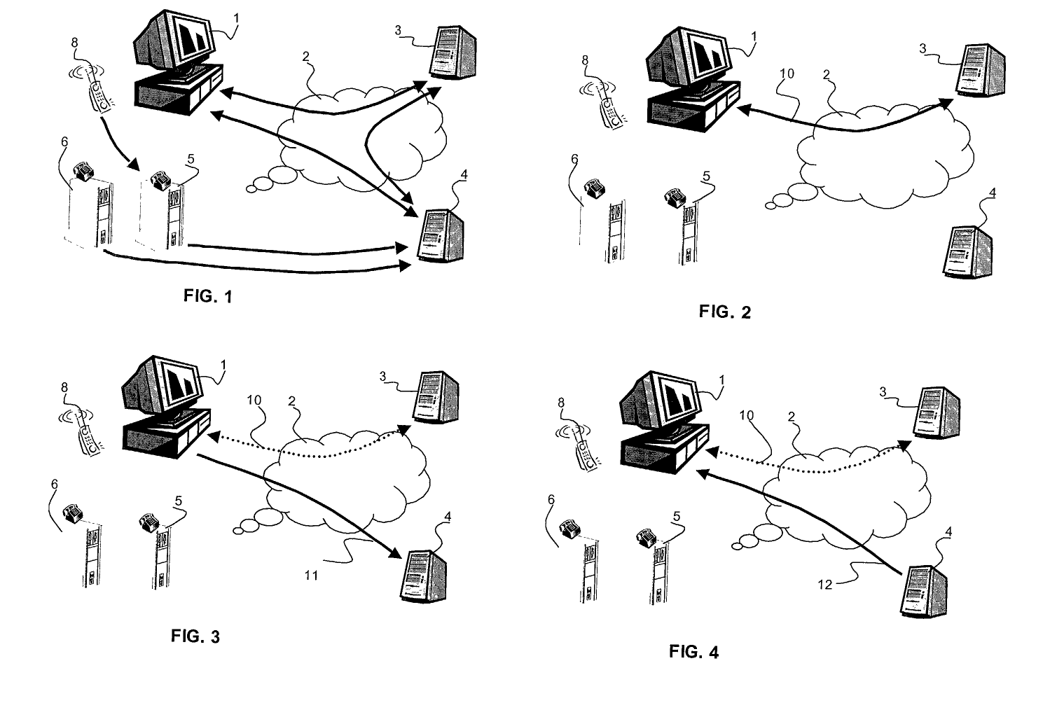

FIG. 1 illustrates in a general way the assembly of devices playing a role in the method in accordance with the invention. Thus, this method allows a transaction between a user (1), represented by a computer connected to Internet. It goes without saying that the method is not limited solely to transactions performed by virtue of a microcomputer, but covers all the variants in which the Internet connection is achieved by some other means such as a portable telephone operating according to WAP technology (“Wireless Application Protocol”) or more generally any terminal able to connect up directly or indirectly to Internet.

The user (1) is linked via Internet (2) to a trader site (3), represented in the form of a computer server. The method in accordance with the invention involves the intervention of a particular party, namely the validation Internet site (4), also represented by a computer server.

The validation Internet site (4) is connected by a secure link to various telephone handlers (5, 6) grouping together a set of premium rate lines. These premium rate lines can be called by the user (1) via a telephone (8). This telephone can be a portable telephone or a fixed telephone operating on the switched telephone network (STN), or else a modem which may or may not be built into the user's computer, this modem then being linked to the switched telephone network.

Specifically, the method in accordance with the invention strings together the various steps illustrated in FIGS. 2 to 11.

Thus, in the step illustrated in FIG. 2, the user (1) is connected to a trader site (3) via Internet (2). This connection is depicted by the arrow (10). In a known manner, the user (1) can purchase goods or services by placing an order on the trader site. He can also order the downloading of computer files which may be programs, or else graphical or musical files. He can also request the display of information requiring payment.

After a few steps of the transaction, the trader site (3) displays on the terminal of the user (1) a window in which it indicates the amount of the transaction, and offers the user the choice between various modes of payment.

In accordance with the invention, the trader site (3) offers the user the option of payment through the use of a premium rate telephone line. When the user wishes to use this mode of payment in accordance with the invention, he clicks on a button of an Internet session window. This button is associated with a number of instructions prompting, on the one hand, a rerouting to the validation Internet site (4) and, on the other hand, the dispatching of a number of information items from the current Internet session.

Once the user has chosen the mode of payment in accordance with the invention, and once he has clicked on the corresponding button of the Internet session, he is rerouted to the validation Internet site as illustrated in FIG. 3. This rerouting is illustrated by the bold arrow (11). It should be noted that this rerouting can be achieved by opening a new Internet session, preserving the session linking with the trader site (3), illustrated by the dashed arrow (10). This makes it possible in particular to preserve on the screen of the user (1) the information relating to the price of the objects ordered by the user.

More precisely, the information dispatched by the user (1) to the validation Internet site (3) can comprise in particular, but not exclusively or compulsorily, the name of the trader site, as well as a code identifying the trader site to the validation Internet site.

This information also comprises the price of the product or of the service to be sold, expressed in the currency indicated by the trader site to the user. This information can also comprise a “price approach procedure” code. Specifically, in view of the great variety of telephone operators offering premium rate lines, it is possible for the sums which will be reimbursed to the trader site to differ from the price which will be charged to the user's telephone bill. Certain telephone operators have, for example, premium rate line tariffs which include fixed sums, or else other specific conditions. A discrepancy therefore occurs between the amount which will be billed to the user on his telephone bill (corresponding to the use of the premium rate line), the amount which will be reimbursed to the validation Internet site by the telephone operator, and the amount which will be reimbursed to the trader site by the validation Internet site.

These discrepancies may furthermore vary as a function of the exchange rates used in the case of multi-currency transactions.

Thus, the “price approach procedure” code indicates the conditions under which a trader site accepts that a transaction has been validated, in view of the various possible aforesaid discrepancies. Thus, in certain particular cases, the trader site may accept only sales in the country of the currency which it has indicated to the user. This makes it possible in particular to limit the sales to a specified geographical area.

In other cases, by virtue of this “price approach procedure” code, the trader site (3) can indicate that it authorizes the transaction regardless of the discrepancies which may arise between the price displayed and the amount which will be reimbursed to it by the validation Internet site.

The trader site (3) may also desire that the transaction be validated for certain plus or minus variations, the limits of which are predetermined. The “price approach procedure” code therefore includes the limit discrepancies, possibly as a percentage, which the trader site authorizes when accepting the transaction.

In addition to the “price approach procedure” code, the information dispatched by the user (1) during the rerouting also comprises a code identifying the authorization procedure via which the transaction will have to terminate. This code indicates to the validation Internet site (4) the process according to which it will have to make the transaction continue, when validation has been performed.

Of course, other complementary information may be dispatched during the rerouting, and in particular a code making it possible to presuppose the country in which the user is located. This code can, for example, be a code representing the language of installation of the Internet navigator software, or any other similar code.

Among the complementary information which can be dispatched during the rerouting, it is possible in particular to include a code identifying a particular process, or scenario, which has to be implemented in order for the keying-in of the control code to be accepted by the telephone handler.

Thus, as illustrated in FIG. 4, after having received all of this information, the validation Internet site (4) sends back (12) information destined for the user (1). This information allows the displaying in the new Internet session of various instructions for the user. This information essentially comprise a telephone number of a premium rate line, and a control code.

The number of the premium rate line is formulated by the validation Internet site (4) by virtue of several parameters. Thus, the country of the user determines the telephone operator which will be used for the call of the premium rate line. The precise number indicated of the premium rate line corresponds to a number the calling of which generates the billing by the telephone operator of an amount corresponding substantially to that of the price displayed for the transaction by the trader site. Stated otherwise, the validation Internet site determines the premium rate line number by choosing the latter from a range of numbers available to it, and the tariff of which corresponds to the amount of the transaction, such as it has been authorized according to the “price approach procedure” mentioned hereinabove.

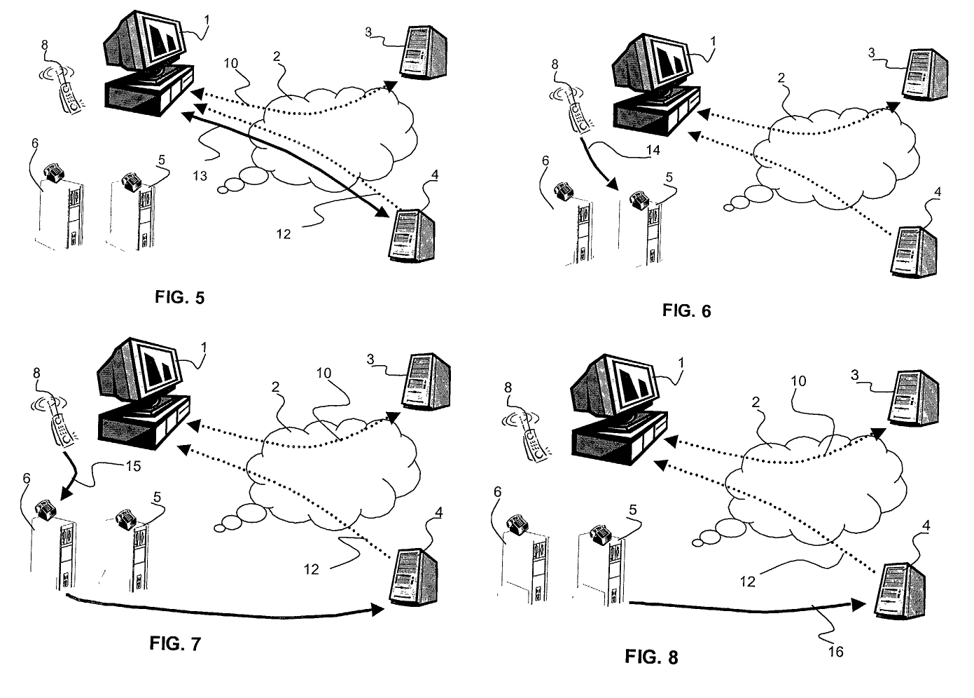

It should be noted that, in an advantageous form, the validation Internet site (4) can offer the user the choice of modifying the default country which it has determined. In this case, as illustrated in FIG. 5, the user (1) can modify the country, thereby bringing about the dispatching (13) of this information to the validation Internet site (4). In return, the validation Internet site (4) causes the displaying of a new premium rate line number, corresponding to the country specified by the user. By virtue of this characteristic, the method is therefore not limited to a particular country and, on the contrary, allows international transactions.

The control code generated by the validation Internet site (4) can comprise four digits and is chosen at random from among ten thousand numbers. Of course, the structure of this code is not limited to this single example, but also covers the variants in which the code incorporates letters and digits, or else possesses more than 4 characters. In practice, this code is generated randomly; after having been generated, the server of the validation Internet site (4) stores the control code and its date of allocation in a database.

When the user (1) has taken cognizance of this number, and of the instruction requesting him to key it in so as to validate his transaction, he can use any telephone line at his disposal.

Thus, as illustrated in FIG. 6, he can use a portable telephone (8) or else some other telephone of the switched telephone network. When the link (14) with the premium rate line is established, he keys in the control code by means of the buttons of his telephone (8). This dispatches DTMF signals over the premium rate line. Once communication has been established, or after a certain interval depending on the country, the amount of the communication with the premium rate line is billed to the subscriber to the line used.

At this instant, the validation Internet site (4) stores, in another commercial database, the information about the nature of the transaction which has just been performed, associating it with a commercial identification code for the trader site. This operation will subsequently allow remuneration of the trader site by the validation Internet site, according to the conditions envisaged upon the contract between these sites. Under certain commercial conditions, the trader site can at any moment look up in real time that part of this other commercial database which concerns him.

It should be noted that if the user wishes to modify the default country proposed by the validation Internet site, he then uses a premium rate line (15) calling a handler (6) situated in some other country, as illustrated in FIG. 7.

In certain illustrative cases, when a particular process or scenario is demanded on the part of the trader site, the user (1) may be requested to key in specific codes demanded by the trader site prior to the control code. Thus, by way of example, for access to sensitive sites such as sites with erotic content, it may be necessary to verify that the user (1) is indeed of the age required to access such sites. Thus, the keying-in of a particular code, such as a code of affiliation to a social security organization, may be requested by the handler, via a voice message. Since this code contains information about the age of the user, it is thus possible to verify that the user's age is indeed the minimum required.

The user may also have, for example, to input an identification code, provided by the trader site, and indicating that the user is in fact one of the persons authorized to perform transactions with this trader site.

More generally, the trader site (3) can define together with the validation Internet site (4), and hence the telephone handler, the necessity to recognize a specific identification scenario allowing authorization of the payment or, as appropriate, refusal to take the call (14) into account.

Thereafter, and as illustrated in FIG. 8, the handler (5) informs the validation Internet site (4) of the call which it has just received. More precisely, this handler (5) is linked to the validation Internet site (4) by the means which allow secure transmission of information. This may therefore be a dedicated link (16) if the handler (5) is remote from the validation Internet site (4). The link may be direct if the handler is built into the validation Internet site (4) and particularly into its server. The transmission of the information from the handler (5) to the validation Internet site (4) via Internet and according to a secure protocol may also be contemplated.

Immediately on receipt of the information from the handler (5), the server of the validation Internet site (4) verifies that the control code is indeed stored in its database. It compares the initial date of allocation with the date of receipt of the control code by the handler. If this difference is greater than five minutes, which duration may be adapted as desired, it dispatches a message of non-validation of the transaction to the user (1).

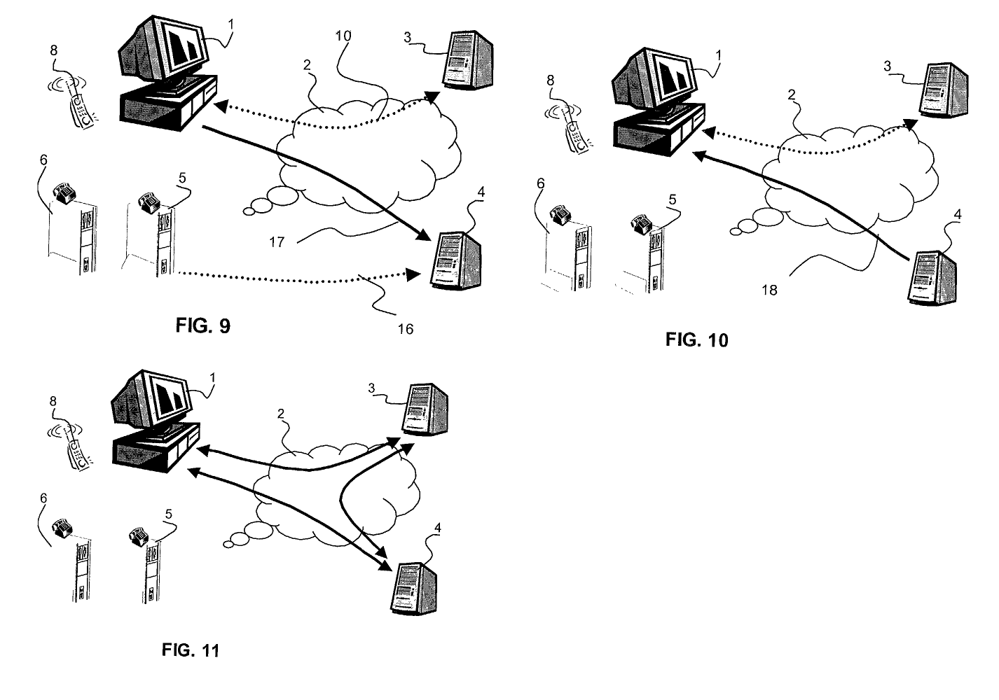

Thereafter, and as illustrated in FIG. 9, the user (1) must confirm to the validation Internet site (4) that he has indeed keyed in the number and the control code. This dispatching is depicted by the arrow (17). For this purpose, he clicks on an appropriate button of the current Internet session. When the validation Internet site (4) receives the cue for this action, it verifies whether it did not occur more than five minutes after the allocating of the identification code.

In the same way as for the previous step, if an excessively large interval has elapsed between allocation and validation by the user, the transaction is rejected.

In other illustrative cases, and as illustrated in FIG. 10, the validation Internet site (4) confirms validation of the transaction to the user (1) by dispatching a message (18) which is displayed on the terminal of the user (1).

Thereafter, and as illustrated in FIG. 11, the validation Internet site (4) terminates its intervention by the authorization given either to the trader site (3) or to the user (1) to continue the transaction. This step, generally called the “authorization process” may assume various forms. This authorization mechanism is chosen by mutual agreement between the trader site (3) and the validation Internet site (4), and forms part of the coded information which is transmitted by the user (1) to the validation Internet site (4) during the rerouting.

Several conventional authorization mechanisms are known. In a first case, the payment may be optional for the customer: these are remunerations commonly called “shareware”, in which it is not necessary to redirect the user to the trader site. In a second illustrative case, the redirecting of the user can be described explicitly in the information dispatched during the rerouting. In a third illustrative case, the redirection can be described in an encrypted manner in the various information transmitted during the rerouting.

In another variant, an electronic mail message can be dispatched to the trader site, together with the partial or total content of the information transmitted during the rerouting. In another variant, the type of redirection can be agreed between the trader site (3) and the validation Internet site (4), and according to various protocols made secure via Internet, or made secure via a dedicated line.

Thereafter, and periodically, the validation Internet site (4) collects sums corresponding to the consumption of the premium rate lines from each telephone operator associated with each handler (5, 6). These sums, less the remuneration of the validation Internet site (4), are then reimbursed to each trader site (3).

It follows from the foregoing that the method in accordance with the invention has multiple advantages and in particular:

it is totally asynchronous with the exchanges of information via Internet between the trader site and the customer;

it is particularly simple for the trader site to implement, since the latter merely needs to incorporate into its Internet pages an inset incorporating the rerouting in accordance with the invention, without any other modification of its Internet site;

it guarantees total anonymity of the user, since payment is made by means of the billing of a premium rate line without any relationship to the type of commodities traded, or the trader site visited;

it is particularly fast since it merely involves a simple telephone call and the keying-in of a few strokes so as to effect the transaction;

it is compatible with international exchanges since for this purpose it suffices for the validation Internet site to have ties with handlers situated in each of the relevant countries.

1. A method of paying for transactions between a user (1) and a trader site (3), comprising a step during which the trader site (1) displays, on a terminal available to the user, information relating to the transaction and to the mode of payment, wherein it comprises the following subsequent steps, during which, starting from the moment at which the user (1) has opted for a mode of payment by billing for the use of a premium rate telephone line:
a) the user (1) is rerouted to a validation Internet site (4), with the dispatching to the said site of the information relating to the transaction;
b) the validation Internet site (4) dispatches to the user (1), via Internet:
the telephone number of a premium rate line, the communication cost of which corresponds substantially to the price of the transaction;
a control code; while requesting the user (1) to key in the telephone number displayed, followed by the control code, and finally to confirm the operation via Internet;
c) on receipt of the call from the user, a telephone handler (5) associated with the premium rate line informs the confirmation Internet site (4) of the control code keyed in, and of the date of the call;
d) the validation Internet site (4) verifies the receipt of the control code transmitted by the handler (5) and of the validation command dispatched by the user (1);
e) the validation Internet site (4) triggers an authorization process allowing the completion of the transaction between the trader site (3) and the user (1).

2. The method as claimed in claim 1, wherein the terminal available to the user (1) is connected to the trader site (3) on Internet, and wherein the validation Internet site (4) dispatches the telephone number of the premium rate line and the control code via a new Internet session.

3. The method as claimed in claim 1, wherein, during the rerouting, the validation Internet site (4) receives a cue relating to the country in which the user (1) is located, and wherein the telephone number of the premium rate line is that of a telephone network of the relevant country.

4. The method as claimed in claim 3, wherein, during the displaying of the telephone number of the premium rate line, the user (1) is offered the choice of modifying the country displayed, such a modification generating the dispatching of a request destined for the validation Internet site (4), then the sending back by the validation Internet site of a new premium rate line telephone number, corresponding to the modified country.

5. The method as claimed in claim 1, wherein the keying-in of the control code brings about the dispatching of DTMF signals to the telephone handler (5).

6. The method as claimed in claim 1, wherein the control code allocated to a transaction is generated randomly.

7. The method as claimed in claim 1, wherein the control code and its date of allocation are stored in a database managed by the validation Internet site (4).

8. The method as claimed in claim 7, wherein, during the verification step, the validation Internet site (4) calculates the duration elapsed between the allocating of the control code and the later of the two events, viz. the receiving of the validation command and the keying-in of the control code, and wherein it triggers the authorization process if this duration is less than a predetermined limit duration.

9. The method as claimed in claim 1, wherein the telephone number of the premium rate line and the control code are keyed in automatically as soon as the user has validated the operation in the Internet session opened by the validation Internet site (4).
